(19) United States
(12) Patent Application Publication
(10) Pub. No.: US 2009/0300732 A1
(43) Pub. Date: Dec. 3, 2009

(54) METHOD AND APPARATUS OF OTP BASED ON CHALLENGE/RESPONSE

(76) Inventors: Jay-Yeob Hwang, Goyang (KR); Giho Yang, Seoul (KR)

Correspondence Address: AMPACC LAW GROUP, 3500 188th St. SW, Lynnwood, WA, 98037, US

(21) Appl. No.: 12/278,945

(22) PCT Filed: Feb. 9, 2007
(86) PCT No.: PCT/KR2007/000728

§ 371 Date: Jan. 16, 2009

(30) Foreign Application Priority Data
Feb. 9, 2006 (KR) 10-2006-0012770

(51) Int. Cl. H04L 9/32; G06F 21/20

(52) U.S. Cl. 726/5

(57) ABSTRACT

The present invention is proposed to solve the problem of high cost of an ordinary OTP token and the problem of vulnerability to hacking of a mobile OTP, for which an OTP program is mounted to solve the problem of high cost. There is provided a user authentication system and a method thereof, in which a user sets an image password as a fixed key, a query terminal outputs a query screen on which a created OTP is divided into pieces and matched to images of the fixed key, the user who confirms the query screen sequentially inputs the numbers that correspond to the image password, i.e., the fixed key of the user himself or herself, and a result of user authentication is processed according to whether the inputted numbers are matched to the response value prepared in a server.

### TECHNICAL FIELD

The present invention relates to a method of an OTP based on query/response and an apparatus therefor, in which if an OTP terminal generates query information, a user analyzes the query and gives an answer to a server, and the server determines whether the answer is correct and authenticates the user.

### BACKGROUND ART

A user authentication method can be largely divided into confirming what only a person knows, confirming what only a person has, and confirming physical features of a person, typical examples of which are a password, a smart card, finger print recognition, and the like.

Among these methods, the method of confirming what only a person has is spotlighted in the aspect of safety. A bank security card (hereinafter, referred to as a security card) that has been used from the past or a one-time password (OTP) that is spotlighted recently can be regarded as such a method.

However, although such a security card or an OTP guarantees very high safety, there is a weak point in that they are vulnerable to theft, loss, and the like. The method of confirming what only a person has inversely is that anyone who possesses the thing is regarded as the very person regardless of who the person really is. Therefore, there is a problem in that even a stranger can act as the owner of a thing if he or she steals or acquires by chance the thing.

FIG. 1 is a view showing an example of a conventional OTP.

Efforts to solve the problems have been made from before. An OTP can be one of those examples. Input of a password is divided in two parts as shown in FIG. 1, and a fixed password of four digits, together with an OTP, is received and authenticated in this method. That is, it is a method of confirming what only a person has and what only a person knows at the same time. This is called as dual factor authentication, through which safety is extremely enhanced compared with single factor authentication.

However, a fixed password itself is so fragile that even such a method cannot be regarded as safe, and in a certain aspect, the method has become more inconvenient as much as it has become safer.

### DISCLOSURE OF INVENTION

### Technical Problem

Accordingly, the present invention has been made in order to solve the vulnerability to theft, loss, or the like of the OTP, and it is an object of the invention to provide a new method that is safe even when what only a person has is lost or stolen, although what only a person has is confirmed in the method.

### Technical Solution

In order to accomplish the above object of the invention, according to one aspect of the invention, there is provided a user authentication system and a method thereof, in which a user sets an image password as a fixed key, a query terminal outputs a query screen on which a created OTP is divided into pieces and matched to images of the fixed key, the user who confirms the query screen sequentially inputs the numbers that correspond to the image password, i.e., the fixed key of the user himself or herself, and a result of user authentication is processed according to whether the inputted numbers are matched to the response value prepared in a server.

### ADVANTAGEOUS EFFECTS

The present invention is effective in that problems related to cost, theft, and loss that a conventional method has are perfectly eliminated.

### BRIEF DESCRIPTION OF THE DRAWINGS

Further objects and advantages of the invention can be more fully understood from the following detailed description taken in conjunction with the accompanying drawings in which:

FIG. 1 is a view showing an example of a conventional OTP;

FIG. 2 is a view showing the basic concept of the present invention;

FIG. 3 is a view showing an embodiment of the present invention;

FIG. 4 is a view showing another embodiment of the present invention;

FIG. 5 is a flowchart illustrating the installation process of a query program; and

FIG. 6 is a flowchart illustrating the authentication process in an embodiment.

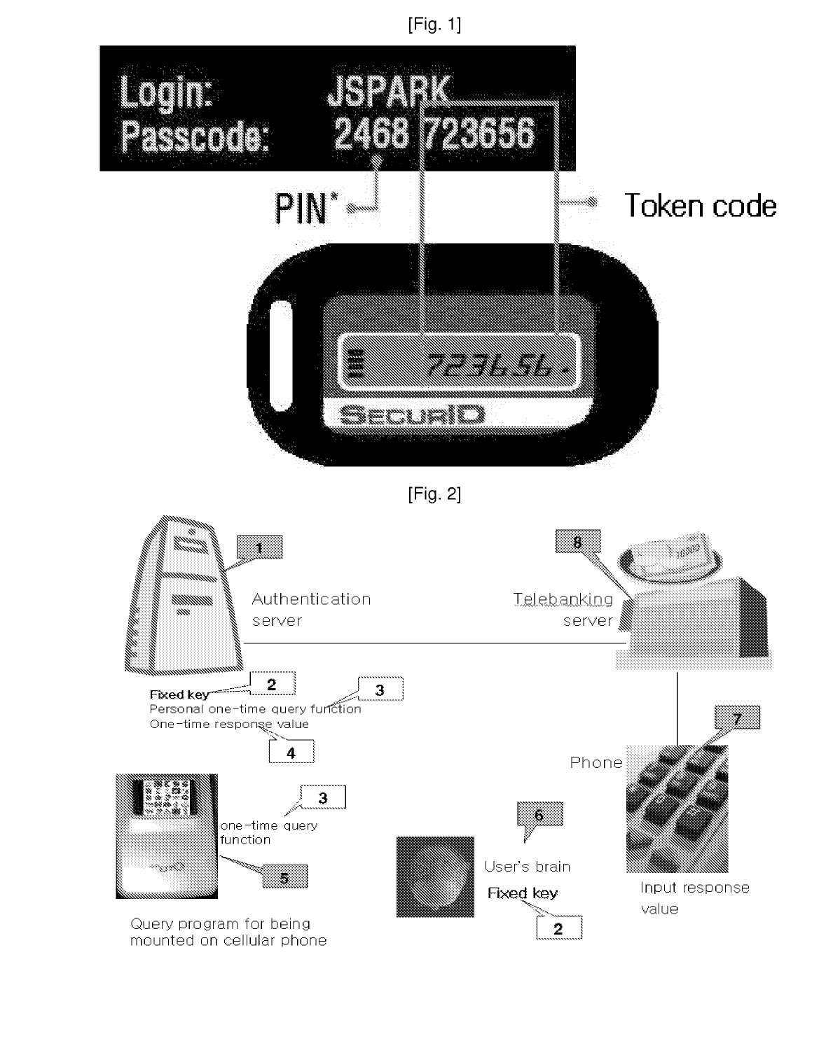

### MODE FOR THE INVENTION

FIG. 2 is a view showing the basic concept of the present invention.

A server 1 prepares a fixed key 2, a query function 3 for creating a one-time query used for confirming the fixed key 2, and a one-time response value 4 matched to the query.

A query terminal 5 prepares a query function 3 that is the same as the query function 3 in the server 2.

In such a system, since the query terminal 5 does not have a fixed key 2 or a response value 4, there is no reason to feel uncomfortable although the query terminal 5 is lost or stolen.

Hereinafter, the concept of the present invention will be will be described in further detail referring to an example applying such a system.

It is assumed that a user has set ‘2314’ as a fixed key, and the query terminal displays an output shown below. At this point, the response value for the query is ‘48652202’ which is a sequential input of ‘48’ ‘65’ ‘22’ and ‘02’ corresponding to each digit of the fixed key respectively.

TABLE 1

| | |
|---|---|
| 1 | 22 |
| 2 | 48 |
| 3 | 65 |
| 4 | 02 |
| 5 | 04 |
| 6 | 64 |
| 7 | 50 |
| 8 | 34 |
| 9 | 75 |
| 0 | 99 |

The numbers shown in the query table are changed every time, and the function that changes the numbers is shared between the server and the query terminal. Accordingly, the user inputs a different eight-digit number each time, and a person who acquires the query terminal cannot easily input a response value without knowing the fixed key. In addition, since the fixed key is not inputted into the password input field, chances of the fixed key to be exposed are diminished.

In the above example, the probability of hitting the response value by chance of an attacker who does not acquire any previous information at all is a 100 million^{th}, i.e., the probability of hitting an eight-digit number, and the probability of hitting a response value by chance of an person who has acquired the query terminal but does not know the fixed key is a ten thousand^{th}, i.e., the probability of hitting a four-digit number.

However, such a method of the aforementioned example can be easily broken since a plain password is used as the fixed key.

Hereinafter, a preferred embodiment of the present will be described.

### Embodiment 1

An OTP that uses an image password as a fixed key (hereinafter, referred to as a graphic OTP)

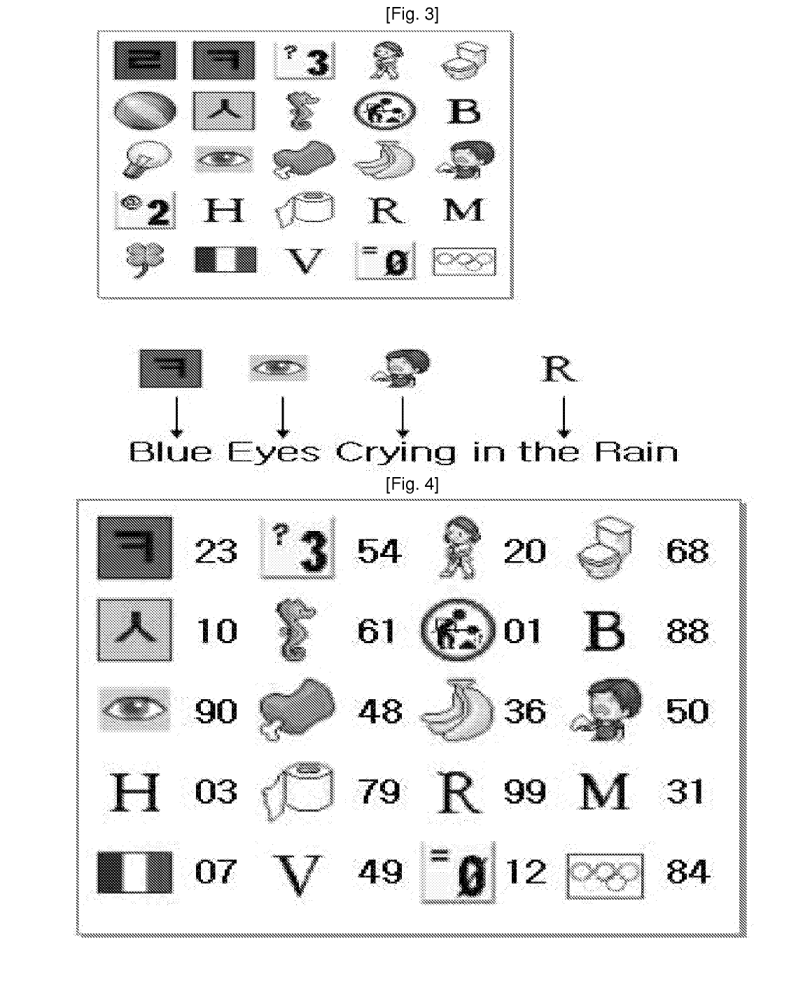

FIG. 3 is a view showing an embodiment of the present invention.

If the example shown in FIG. 3 is a user's image password (a fixed key), the response value based on the query table of FIG. 3 is ‘23 90 50 99’

According to the embodiment, it is almost impossible to conjecture an image password of other person, and thus using an image password as a fixed key can be much safer than using a plain password. In addition, since only good points of an image password and an OTP are adopted in the present embodiment, there is almost no weak point. That is, since the image password is basically in memory of a user, there is no worry about physical loss or theft, and it is difficult to guess the image password. However, the image password is vulnerable to shoulder surfing, screen capture, and the like. The OTP is robust to hacking, but vulnerable to loss and theft. However, according to the present embodiment, all the weak points are cleared.

In addition, the image password cannot be used for telebanking where a screen monitor is not used. However, according to the embodiment, even a phone that does not have a screen monitor can use the image password.

### Embodiment 2

An OTP that uses a maze method as a fixed key (hereinafter, referred to as a maze OTP)

FIG. 4 is a view showing another embodiment of the present invention.

If a user's fixed key is as shown in FIG. 4, the response value for the query shown in FIG. 4 is ‘↓,↓,confirm,→,→,→,confirm,↓,←,confirm’. A method of passing a maze is starting from a first key, and subsequently moving to next keys and pressing a confirmation key. The maze method is described in detail in Korean Patent No. 10-0625081-0000.

If the maze OTP is desired to be used for telebanking, the numeric pad on a phone can be used as direction keys. For example, buttons 2, 8, 4, and 6 are respectively used as up, down, left, and right direction keys. The button ‘*’ or the like can be used as a confirmation key.

Also in this embodiment, although a query terminal is lost or stolen, since the query terminal in itself does not have any hint on a fixed key or a response value, a user can be safe.

### Embodiment 3

This is a method that can be commonly applied to both embodiments 1 and 2 described above, which is advantageous in that if a query program is mounted on a handheld information device, such as a cellular phone, a MP3 player, or the like, instead of using a query terminal, cost required for the system can be greatly reduced. Hereinafter, the present embodiment will be referred to as a mobile graphic OTP and a mobile maze OTP.

A conventional OTP mounted and used on a cellular phone is disadvantageous in that it is unsafe from hacking since the cellular phone itself is connected to a network. However, the methods according to the present invention are advantageous in that although the query program is mounted on a cellular phone, the program itself does not have any hint on a fixed key or a response value. Therefore, a user is sufficiently safe although the program is hacked.

This graciously solves the problems of cost in an existing OTP token method and vulnerability to hacking in a cellular phone type OTP method.

Embodiments according to the present invention have been described above.

Hereinafter, implementation processes of the embodiments according to the present invention will be described.

In the third embodiment, a process of setting an image that is to be used as a fixed key and downloading his or her query program to a handheld information device is performed by a user. First, if a fixed key inputted by the user is set from a set screen formed with a variety of images provided through online such as the Internet, the server constructs a personal set by filling the personal set with extra images, together with the set fixed key, and creates a personal query program package including an OTP function used for randomly pairing a number with an image (a mobile graphic OTP) or randomly shuffling images (a mobile maze OTP). If the query program package is created, the program is downloaded and installed in the handheld information device in an ordinary wireless transmission method. At this point, the downloaded query program package does not contain the user's fixed key. The fixed key is stored only in the server. In addition, the created query program is also stored in the server and creates a query that is always the same as a query created by the handheld query program.

After creating a query, the query program in the server calculates a response value for the query referring to the fixed key and stores the response value in the memory within the server. If the user inputs a response value, the inputted response value is compared with the response value stored in the memory. If they are the same, the authentication is processed as a success, whereas if they are different, the authentication is processed as a failure.

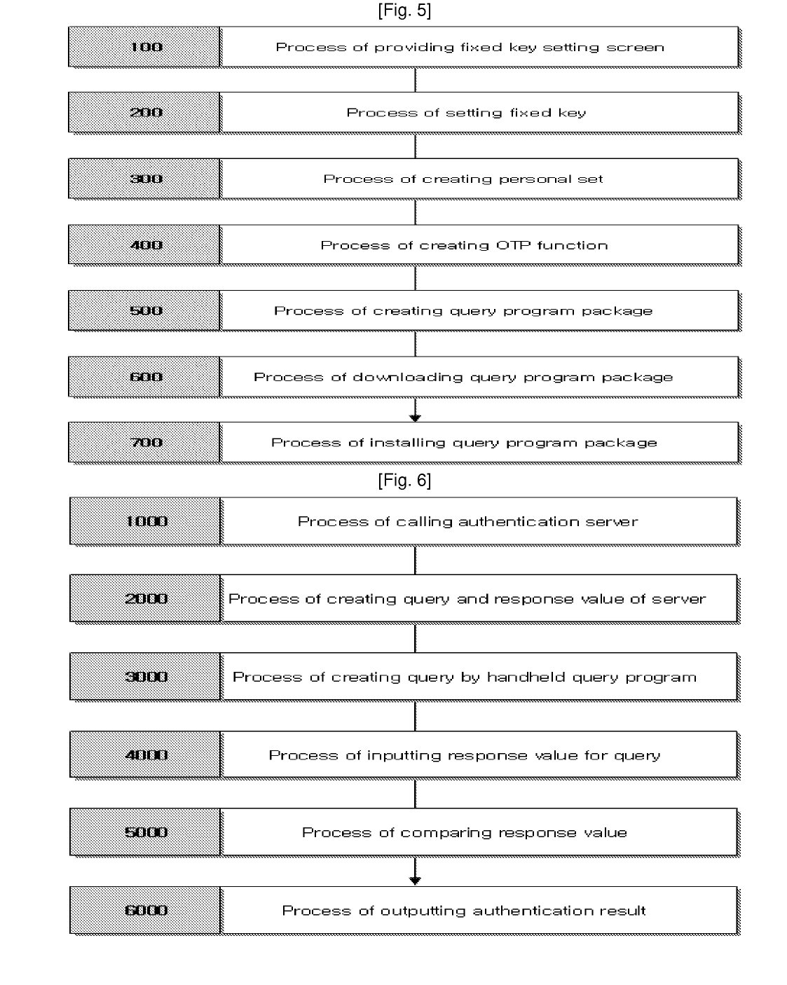

FIG. 5 is a flowchart illustrating the installation process of a query program.

100: process of providing a fixed key setting screen the server outputs a plurality of icons assigned with a number, thereby providing a fixed key setting screen for a user to select icons that function as a fixed key.

200: process of setting a fixed key if the user selects a fixed key from the fixed key setting screen and presses a confirmation key, the server records the fixed key in a user database (DB).

300: process of creating a personal set the server shuffles the fixed key icon with certain extra icons and creates and stores a user's personal set formed with a plurality of the icons.

400: process of creating an OTP function the server creates and stores an OTP function having information on the personal set as a parameter. In this process, a specific serial number or the like can be used as a parameter instead of the personal set information.

500: process of creating a query program package the server assembles constitutional elements to be executed in a query terminal, such as the personal set, a program for driving the OTP function, and the like, and creates a query program package.

600: process of downloading the query program package the server transmits the query program package to a cellular phone through a cellular download function.

700: process of installing the query program package the user's cellular phone downloads the query program package and installs the query program and the personal set information following a certain procedure.

FIG. 6 is a flowchart illustrating the authentication process in an embodiment of telebanking.

1000: process of calling an authentication server a telebanking server calls the authentication server in order to issue a query.

2000: process of creating a query and a response value of the server the called authentication server creates a query and a response value corresponding to the query using the OTP function created in the process of creating an OTP function. When creating the query, in order to create a query that is the same as the query created by the query terminal, the authentication server uses parameters, such as a time that can be commonly used, e.g., current time, the number of authentications, and the like.

3000: a process of creating a query by the handheld query program if the user executes the query program of the cellular phone, the query program creates a query that is the same as the query created by the authentication server using the same OTP function and parameters as those of the authentication server.

4000: a process of inputting a response value for the query if the user views the query and inputs a corresponding response value through the cellular phone, the input information is transferred to the authentication server.

5000: a process of comparing the response value the authentication server compares the previously created response value with the response value inputted through a telephone network.

6000: a process of outputting the authentication result the authentication server outputs and transfers the result of the comparison to the telebanking server.

[An Embodiment where Security is Further Reinforced]

In the case of the mobile graphic OTP or mobile maze OTP, if a response value is eavesdropped while a query program is hacked, a fixed key can be conjectured. The query program is not safe any more if the fixed key is also exposed, and thus it is preferable to apply an input information exposure prevention technique to a response value input program.

An anti-key logger technique is widely used as such a technique that is used in an ordinary web environment. An anti-key logger technique that can be used in a telebanking environment is introduced in Korean Patent No. 0503924, “Telephone network information protection system and method thereof.

Only by taking the measures described above, the mobile graphic OTP or the mobile maze OTP can be a user authentication method that is extremely economical and almost perfectly safe.

Furthermore, if the concept of a trap is employed, even a brute force attack can be blocked from the source.

Here, a method of setting a trap on the mobile graphic OTP and the mobile maze OTP is described. When the query program package is initially downloaded to a handheld information device, information on the terminal (cellular phone number, and the like) is recorded. If authentication of the mobile graphic OTP or the mobile maze OTP is failed, an alarm message is transmitted to a corresponding terminal. A person who receives the alarm message can ignore the alarm message if the authentication is failed due to his or her fault, or can report the alarm to corresponding authorities if it is determined that other person is attacking the system.

1. A user authentication system comprising:
a server that prepares a user's fixed key, a personal query function for creating a one-time query for confirming whether a user knows the fixed key, and a correct response value for the one-time query, wherein a response value inputted from the user is compared with the response value stored in the server, and a result of authentication is processed according to a result of the comparison; and
a query terminal mounted with a query function that is the same as the personal query function within the server.

2. The system according to claim 1, wherein the user's fixed key is set to images, the query function is a function that matches an arbitrary number to each of the images, the response value is a number matching to the images that correspond to the fixed key, and the query terminal displays all numbers respectively matching to the images.

3. The system according to claim 1, wherein the user's fixed key is set to images, the query function is a function that randomly shuffles the images, the response value is a set of relative coordinates among the images corresponding to the fixed key, and the query terminal displays the images that are randomly shuffled by the query terminal.

4. The system according to claim 1, wherein the query terminal is a cellular phone mounted with a query program.

5. A user authentication method comprising:
A) a user authentication service preparation step comprising the steps of:
A-1) allowing a server to provide a fixed key setting screen so that a user can set a fixed key;
A-2) allowing the user to set a fixed key through the fixed key setting screen provided by the server;
A-3) creating a personal set including the set fixed key;
A-4) creating an OTP function for a one-time query;
A-5) creating a query program package including the personal set and the OTP function;
A-6) downloading the query program package to a handheld information device of the user; and
A-7) installing the downloaded query program package in the handheld information device of the user, and
B) a user authentication step comprising the steps of:
B-1) allowing a site that needs user authentication to call an authentication server;
B-2) allowing a user's query program in the authentication server to create a one-time query and a response value therefor referring to the user s fixed key;
B-3) allowing a user's handheld query program to create a one-time query;
B-4) allowing the user to input a response value for the one-time query;
B-5) comparing the inputted response value with the response value in the server; and
B-6) processing the authentication as a success if the inputted response value is the same as the response value in the server, whereas processing the authentication as a failure if the inputted response value is not the same as the response value in the server.
